(19) United States
(12) Patent Application Publication
(10) Pub. No.: US 2022/0290895 A1
(43) Pub. Date: Sep. 15, 2022

(54) ELECTRIC RADIATOR COMPRISING A THERMAL PROTECTION SHIELD BETWEEN THE HEATING MEMBER AND A REMOVABLE ELECTRICAL ENERGY STORAGE DEVICE

(71) Applicant: LANCEY ENERGY STORAGE, Grenoble (FR)

(72) Inventors: Gilles MOREAU, Grenoble (FR); Yohann CHATILLON, St jean de moirans (FR); Adrien TANGHE, Saint Pierre d'Albigny (FR)

(21) Appl. No.: 17/639,652

(22) PCT Filed: Sep. 4, 2020
(86) PCT No.: PCT/FR2020/051536

§ 371 Date: Mar. 2, 2022

(30) Foreign Application Priority Data
Sep. 5, 2019 (FR) FR1909799

(51) Int. Cl. F24H 3/00; F24H 9/02

(52) U.S. Cl. CPC F24H 3/002; F24H 9/02

(57) ABSTRACT

An electric radiator is described, having a housing, delimiting an upper compartment and a lower compartment, at least one heating member installed in the upper compartment and capable of emitting thermal radiation when it is supplied with electrical power, at least one electrical energy storage device, an attachment device enabling the removable installation of the electrical energy storage device in the lower compartment, in such a way that the electrical energy storage device is capable of varying between a connection configuration and a disconnection configuration, and a heat protection shield located between the heating member and the electrical energy storage device and blocking infrared rays while allowing the movement of air by convection, which are emitted in the direction of the electrical energy storage device.

### TECHNICAL FIELD

The present disclosure relates to an electric radiator including:
a case adapted to be attached to a vertical attachment element,
at least one heating member adapted to emit a heat radiation when it is supplied with electric current,
at least one electrical energy storage device likely to power the heating member.

### BACKGROUND

In the field of electric radiators comprising an electrical energy storage device, conventionally a battery, it is important to secure the batteries and people, because such batteries might be degraded voluntarily or not or become deformed and even explode, typically if they are subjected to an excessive heat.

There is therefore a need to avoid as much as possible the causes of deterioration of the batteries.

There is also a need to protect people in the case where the batteries had just experienced a major safety event, in particular likely to produce the generation of a physical flow that is dangerous for people, such as a flow of heat or vapor or still an overpressure.

### SUMMARY

The present disclosure provides an electric radiator of the aforementioned type, allowing addressing all or part of the problems presented above.

In particular, the disclosure provides a solution that addresses at least one of the following advantages:
confer a good efficiency of the electric radiator,
limit the causes of deterioration of the electrical energy storage device,
propose an electric radiator conferring a good safety for people, even in case of a major safety event of the electrical energy storage device,
propose safe and simple interventions on the electrical energy storage device, in particular a replacement.

This advantage can be achieved by providing an electric radiator including:
a case adapted to be attached to a vertical attachment element, the case delimiting an upper compartment and a lower compartment disposed under the upper compartment when the case is attached to the vertical attachment element,
at least one heating member installed in the upper compartment and adapted to emit a heat radiation when it is supplied with electric current,
at least one electrical energy storage device likely to power the heating member,
an attachment device allowing installing the electrical energy storage device removably in the lower compartment, in such a way that the electrical energy storage device is adapted to vary between a connection configuration in which the electrical energy storage device is installed in the lower compartment and is likely to be able to supply the heating member with electrical energy and a disconnection configuration in which the electrical energy storage device is electrically disconnected from the heating member and is arranged outside the case,
a thermal protection shield located between the heating member and the electrical energy storage device at the interface between the upper compartment and the lower compartment and blocking at least one infrared radiation and thermal transfer of the heat radiation which are emitted by the heating member in the direction of the electrical energy storage device to avoid the direct incidence of said thermal rays on the electrical energy storage device.

Some preferred yet non-limiting aspects of the electric radiator are as follows.

In one implementation, the case comprises at least one closure wall partially delimiting the lower compartment and movable relative to the rest of the case between a closure configuration in which the closure wall seals the second compartment in a way preventing the switch of the electrical energy storage device from the connection configuration to the disconnection configuration, and an opening configuration in which the case delimits an opening through which the electrical energy storage device can be moved to switch from the disconnection configuration to the connection configuration and vice versa.

In one implementation, the electric radiator comprises electronic components ensuring a modulation of the electric power supply of the heating member and wherein a protection device is arranged at least in part around the electronic components so as to make the electronic components not accessible from outside the case when the closure wall occupies its opening configuration.

In one implementation, the closure wall is a solid wall.

In one implementation, the electric radiator comprises a removable closure device enabling the integral attachment of the closure wall, when it occupies its closure configuration, to the rest of the case.

In one implementation, the thermal protection shield is formed of at least one solid protection plate arranged between the electrical energy storage device and the heating member.

In one implementation, at least one heat dissipation opening is arranged around the protection plate, said heat dissipation opening ensuring a communication between the lower compartment and the upper compartment at a location adapted to avoid a direct incidence of the infrared radiation and of the thermal transfer of the heat radiation which are emitted by the heating member and which pass through said heat dissipation opening on the electrical energy storage device; the heat dissipation opening being arranged to allow thermal transfer from the electrical energy storage device with the air via an upward natural convection movement to the heating member.

In one implementation, the case includes apertures conferring a communication between the lower compartment and the outside of the case, said apertures being formed in a lower wall of the case intended to face the ground and in a rear wall of the case intended to face the vertical attachment element.

In one implementation, the attachment device comprises a support structure on which the electrical energy storage device rests when it occupies its connection configuration.

In one implementation, the electrical energy storage device comprises a battery based on an assembly of electrochemical cells and/or a supercapacitor and/or a fuel cell.

### BRIEF DESCRIPTION OF THE DRAWINGS

Other aspects, aims, advantages and features of the disclosure will appear better on reading the following detailed description of preferred embodiments thereof, provided as a non-limiting example, and made with reference to the appended drawings in which:

FIG. 1 illustrates schematic views in front section and in cross-section of an example of an electric radiator according to the disclosure, the closure wall of which occupies its closure configuration.

FIG. 2 illustrates a front perspective view of another example of an electric radiator according to the disclosure, the closure wall of which occupies its opening configuration.

FIG. 3 illustrates a rear perspective view of the electric radiator of FIG. 2, the rear wall being absent to show the interior of the electric radiator.

### DETAILED DESCRIPTION OF THE DRAWINGS

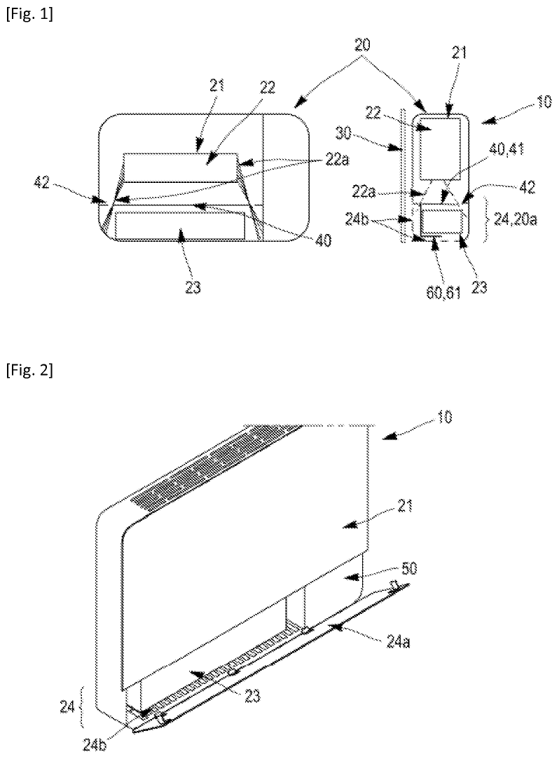

In the appended FIGS. 1 to 3 and in the rest of the description, elements which are identical or similar in functional terms are identified by the same references. In addition, the different elements are not represented to scale so as to favor the clarity of the figures to facilitate understanding thereof. Furthermore, the different embodiments and variants are not mutually exclusive and can, on the contrary, be combined with each other.

In the rest of the description, unless otherwise indicated, the terms “substantially”, “approximately”, “overall” and “of the range of” mean “within 10%”.

As illustrated in FIGS. 1 and 2, the disclosure relates to an electric radiator 10, in other words a heating apparatus intended to heat the air of a room in which the electric radiator is installed.

The electric radiator 10 includes a case 20 adapted to be attached to a vertical attachment element 30. The vertical attachment element 30 is for example a wall or a post. In one example, the case 20 is formed in one or several material(s) such as steel or different metals, plastic or even glass.

The case 20 delimits an upper compartment 21 and a lower compartment 24 disposed under the upper compartment 21 when the case 20 is attached to the vertical attachment element 30.

The electric radiator 10 also includes at least one heating member 22 installed in the upper compartment 21 and adapted to emit a heat radiation 22a when it is supplied with electric current. The electric current supply can be direct or indirect via a power electronics which can control and/or vary the current or voltage supply of the heating member 22. Electronic components can for example ensure a modulation of the electric power supply of the heating member 22.

In one example, illustrated in FIG. 2, a protection device 50 is arranged at least in part around these electronic components so as to make the electronic components not accessible from outside the case 20, including, when a closure wall 24a described below occupies its opening configuration. This allows securing access to these components.

The electric radiator 10 also includes at least one electrical energy storage device 23 likely to power the heating member 22. According to a particular yet very advantageous embodiment, the electrical energy storage device 23 comprises a battery based on an assembly of electrochemical cells and/or a supercapacitor and/or a fuel cell.

As illustrated in FIGS. 1 and 2, the electric radiator 10 also includes an attachment device 60 allowing installing the electrical energy storage device 23 removably in the lower compartment 24 in such a way that the electrical energy storage device 23 is adapted to vary between:
a connection configuration in which the electrical energy storage device 23 is installed in the lower compartment 24 and is likely to supply the heating member 22 with electrical energy,
and a disconnection configuration in which the electrical energy storage device 23 is electrically disconnected from the heating member 22 and is arranged outside the case 20.

In one example illustrated in FIG. 1, the attachment device 60 comprises a support structure 61 on which the electrical energy storage device 23 rests when it occupies its connection configuration. The support structure 61 includes for example mechanical solutions (metal brackets, attachment rails, plastic or metal links . . . ) or chemical solutions (glues, adhesives . . . ). This is advantageous for allowing a quick and secure replacement of the electrical energy storage device 23.

Very advantageously in order to address the problems presented in connection with the state of the art, the electric radiator 10 also includes a thermal protection shield 40 located between the heating member 22 and the electrical energy storage device at the interface between the upper compartment 21 and the lower compartment 24. The thermal protection shield 40 blocks at least the thermal rays of the heat radiation 22a, i.e. an infrared radiation and a thermal transfer, which are emitted by the heating member 22 in the direction of the electrical energy storage device 23 to avoid the direct incidence of said thermal rays on the electrical energy storage device 23. This is advantageous to allow limiting the rise of the temperature of the electrical energy storage devices 23 when the radiator is in operation.

In one exemplary implementation illustrated in FIG. 2, the case 20 comprises at least one closure wall 24a partially delimiting the lower compartment 24 and movable relative to the rest of the case 20 between:
a closure configuration in which the closure wall 24a seals the second compartment 24 in a way preventing the passage of the electrical energy storage device 23 from the connection configuration to the disconnection configuration,
an opening configuration in which the case 20 delimits an opening through which the electrical energy storage device 23 can be moved to switch from the disconnection configuration to the connection configuration and vice versa.

In one example, the closure wall 24a pivots to seal the second compartment 24. In another example, the closure wall 24a can be clipped onto the second compartment 24 to close it. In one example, the closure wall 24a is a solid wall. This is advantageous for securing the user from the risk of explosion or liquid or vapor splashes inherent to a major safety event of the electrical storage device 23.

In one additional example, a removable closure device enables the integral attachment of the closure wall 24a, when it occupies its closure configuration, to the rest of the case 20. The removable closure device is formed by at least one screw, or by at least one magnet, or by any other equivalent removable attachment means. This is advantageous to safeguard the user from the risk of explosion or projections inherent to a dangerous physical flow (for example of heat, vapor, or overpressure) originating coming from the electrical storage device 23.

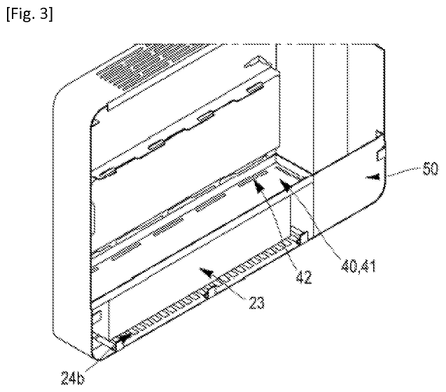

In one implementation of the electric radiator illustrated in FIG. 3, the thermal protection shield 40 is formed of at least one solid protection plate 41 arranged between the electrical energy storage device 23 and the heating member 22. This is advantageous to allow limiting the rise of the temperature of the electrical energy storage devices 23. This also allows limiting or containing the risks of explosion or projections originating from the electrical energy storage device 23 upon a major safety event.

In one additional implementation of the electric radiator illustrated in FIGS. 1 and 3, at least one heat dissipation opening 42 is arranged around the protection plate 41. This heat dissipation opening 42 ensures a communication between the lower compartment 24 and the upper compartment 21 at a location adapted to avoid a direct incidence of the thermal rays of the heat radiation 22a which are emitted by the heating member 22 and which pass through the heat dissipation opening 42 on the electrical energy storage device 23. In other words, the heat dissipation opening 42 is adapted to prevent the thermal transfer by radiation, in particular direct infrared, from the heating member 22 to the electrical energy storage device 23. The heat dissipation opening 42 is further arranged to allow a thermal transfer from the electrical storage device 23 with the air via an upward natural convection movement to the heating member. This is advantageous for allowing the heat emitted by the electrical energy storage device 23 to be removed. Another advantage is to increase the efficiency of the radiator by adding, to the energy developed by the heating member 22, the thermal energy released by the electrical energy storage device 23.

In one additional implementation of the electric radiator illustrated in FIGS. 1 to 3, the case 20 includes apertures 24b conferring a communication between the lower compartment 24 and the outside of the case 20. Said apertures 24b are formed in a lower wall of the case 20 intended to face the ground and in a rear wall of the case 20 intended to face the vertical attachment element 30. This allows heat to be evacuated by natural convection while protecting the user from projections and explosions because the apertures are disposed downwards and to the rear. The apertures 24b also advantageously allow promoting an upward natural convection around the electrical energy storage device, by creating an air inlet in the lower portion of the radiator. The air, drawn by natural convection through the apertures 24b, is heated by the energy storage device 23 and thus has an upward trajectory to pass through the heat dissipation opening 42 and add to the heat developed by the heating member 22.

1. An electric radiator comprising: a case adapted to be attached to a vertical attachment element, the case delimiting an upper compartment and a lower compartment disposed under the upper compartment when the case is attached to the vertical attachment element, at least one heating member installed in the upper compartment and adapted to emit a heat radiation when the at least one heating member is supplied with electric current, at least one electrical energy storage device configured to power the heating member, an attachment device allowing installing the electrical energy storage device removably in the lower compartment, such that the electrical energy storage device is adapted to vary between a connection configuration in which the electrical energy storage device is installed in the lower compartment and is configured to supply the heating member with electrical energy and a disconnection configuration in which the electrical energy storage device is electrically disconnected from the heating member and is arranged outside the case, a thermal protection shield located between the heating member and the electrical energy storage device at the interface between the upper compartment and the lower compartment and blocking at least one infrared radiation and thermal transfer of the heat radiation which are emitted by the heating member in the direction of the electrical energy storage device to avoid a direct incidence of said infrared radiation and thermal transfer on the electrical energy storage device.

2. The electric radiator according to claim 1, wherein the case comprises at least one closure wall partially delimiting the lower compartment and movable relative to the rest of the case between: a closure configuration in which the closure wall seals the second compartment in a way preventing the switch of the electrical energy storage device from the connection configuration to the disconnection configuration, an opening configuration in which the case delimits an opening through which the electrical energy storage device can be moved to switch from the disconnection configuration to the connection configuration and vice versa.

3. The electric radiator according to claim 2, comprising electronic components ensuring a modulation of the electric power supply of the heating member and wherein a protection device is arranged at least in part around the electronic components so as to make the electronic components not accessible from outside the case when the closure wall occupies the opening configuration.

4. The electric radiator according to claim 2, wherein the closure wall is a solid wall.

5. The electric radiator according to claim 2, comprising a removable closure device enabling the integral attachment of the closure wall, when the closure wall occupies the closure configuration, to the rest of the case.

6. The electric radiator according to claim 1, wherein the thermal protection shield is formed of at least one solid protection plate arranged between the electrical energy storage device and the heating member.

7. The electric radiator according to claim 6, wherein at least one heat dissipation opening is arranged around the protection plate, said heat dissipation opening ensuring a communication between the lower compartment and the upper compartment at a location adapted to avoid a direct incidence of the infrared radiation and of the thermal transfer of the heat radiation which are emitted by the heating member and which pass through said heat dissipation opening on the electrical energy storage device;
the heat dissipation opening 42 being arranged to allow a thermal transfer from the electrical energy storage device with the air via an upward natural convection movement to the heating member.

8. The electric radiator according to claim 6, wherein the case includes apertures conferring a communication between the lower compartment and the outside of the case, said apertures being formed in a lower wall of the case intended to face the ground and in a rear wall of the case intended to face the vertical attachment element.

9. The electric radiator according to claim 1, wherein the attachment device comprises a support structure on which the electrical energy storage device rests when the electrical energy storage device occupies the connection configuration.

10. The electric radiator according to claim 1, wherein the electrical energy storage device comprises a battery based on an assembly of electrochemical cells and/or a supercapacitor and/or a fuel cell.
